(19) United States
(12) Patent Application Publication
(10) Pub. No.: US 2013/0164985 A1
(43) Pub. Date: Jun. 27, 2013

(54) UNIVERSAL SERIAL BUS CONNECTOR

(71) Applicants: WEI-DONG CONG, Shenzhen City (CN); LEI LIU, Shenzhen City (CN)

(72) Inventors: WEI-DONG CONG, Shenzhen City (CN); LEI LIU, Shenzhen City (CN)

(21) Appl. No.: 13/663,494

(22) Filed: Oct. 30, 2012

(30) Foreign Application Priority Data
Dec. 27, 2011 (CN) 201110444425.8

(51) Int. Cl. H01R 13/40

(52) U.S. Cl. 439/625

(57) ABSTRACT

A universal serial bus connector includes a box-shaped shell with a front side open and a number of kernels to be selectively and detachably received in the shell. Four first pins are arranged on an inner surface of a bottom of the shell. Each kernel defines a hole with a fixing piece held therein. Four second pins are arranged on an inner surface of a bottom of the kernel to be respectively connected to the first pins. A number of third pins are arranged on the surface of the fixing piece and respectively coupled to the second pins. When one kernel is housed in the shell, the third pins of the kernel are coupled to the first pins through the second pins, respectively.

### BACKGROUND

1. Technical Field

The present disclosure relates to a universal serial bus (USB) connector.

2. Description of Related Art

USB interfaces are important parts of computers for connecting to external devices. The USB interfaces include many types, such as type A, type B, micro-B, and mini B. The type A USB interface is widely equipped in the computer. It is impractical for a manufactory to arrange all of the different types of USB interfaces on a motherboard, due to a large amount of space needed. However, if other types of USB interfaces are needed, such as type B, a user may need to buy anther motherboard with type B USB interfaces, which is costly.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is an exploded, isometric view of an embodiment of a universal serial bus (USB) connector, wherein the connector includes a shell and a kernel.

FIG. 2 is an enlarged view of the kernel shown in FIG. 1, but viewed from another perspective.

FIG. 3 is an exploded view of the shell of FIG. 1 and another kernel.

FIG. 4 is an enlarged view of the kernel shown in FIG. 3.

FIGS. 5 and 6 are views of using states of the connectors of FIG. 1 and FIG. 3, respectively.

### DETAILED DESCRIPTION

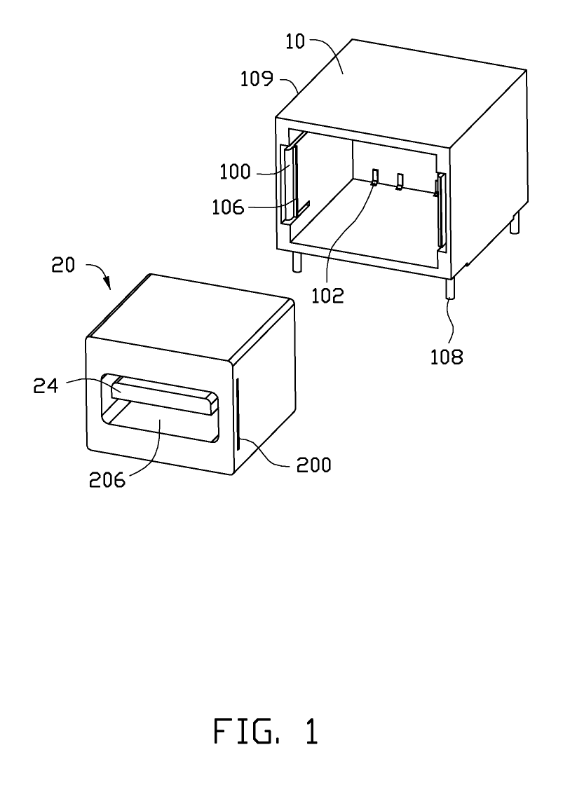

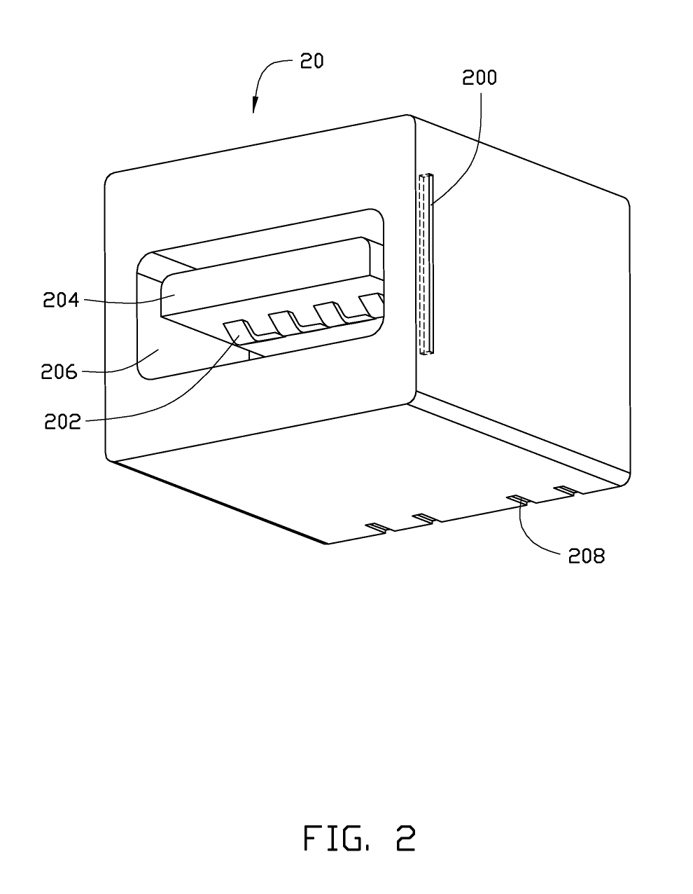

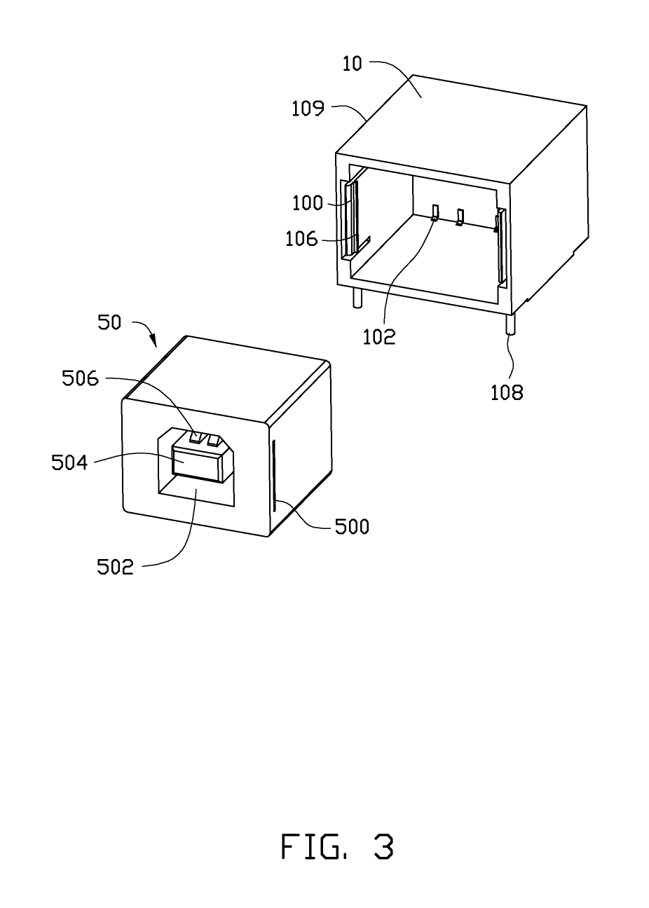

FIGS. 1 and 2 illustrate an embodiment of a universal serial bus (USB) connector of the present disclosure. The connector includes a shell 10 and a plurality of exchangeable kernels. In the embodiment, the exchangeable kernels include an exchangeable first kernel 20 and an exchangeable second kernel 50 (shown in FIG. 3).

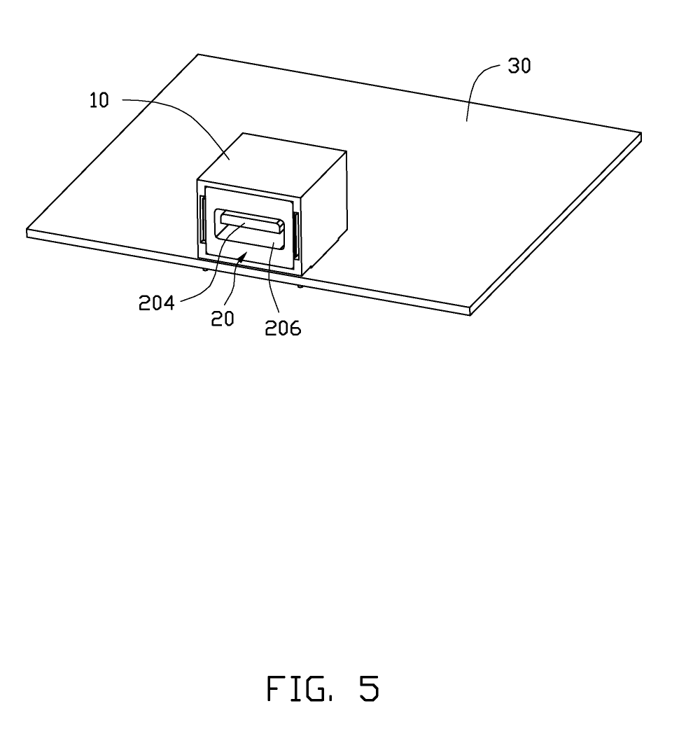

The shell 10 includes a box-shaped housing 109 with a front side open, and a plurality of fixing pins 108 extending down from a bottom wall of the housing 109 to fix the shell 10 to a motherboard 30 (shown in FIG. 5). The housing 109 is used to house the first kernel 20 or the second kernel 50. Two elastic snaps 100 extend forward from inner surfaces of the left and right sidewalls of the housing 109. Each snap 100 includes a substantially wedge-shaped hook 106 formed on an inner surface of a front end of the snap 100. Four first pins 102 are formed on an inner surface of the bottom wall of the housing 109, adjacent to a rear wall of the housing 109.

The first pins 102 include a +5 volt power pin, two data pins, and a ground pin. When the shell 10 is welded to the motherboard 30 by the fixing pins 108, the first pins 102 are electrically coupled to the motherboard 30.

In the embodiment, the first kernel 20 is a male interface of type A. The first kernel 20 is substantially rectangular, and defines a first hole 206 in a front side of the first kernel 20. A first fixing piece 204 is housed in the first hole 206. Four second pins 202 are arranged on a bottom side of the first fixing piece 204. Four third pins 208 are arranged on a bottom of the first kernel 20, and coupled to the second pins 202, respectively. When the first kernel 20 is received in the housing 109, the first pins 102 are coupled to the third pins 208, respectively, so that the second pins 202 are coupled to the first pins 102 through the third pins 208, respectively. Two slots 200 are defined in outer surfaces of the left and right sides of the first kernel 20. When the first kernel 20 enters the housing 109, the snaps 100 are deformed away from each other. After the first kernel 20 is received in the housing 109, the snaps 100 are restored, thus the hooks 106 are engaged in the corresponding slots 200. Therefore, the first kernel 20 is fixed in the shell 10.

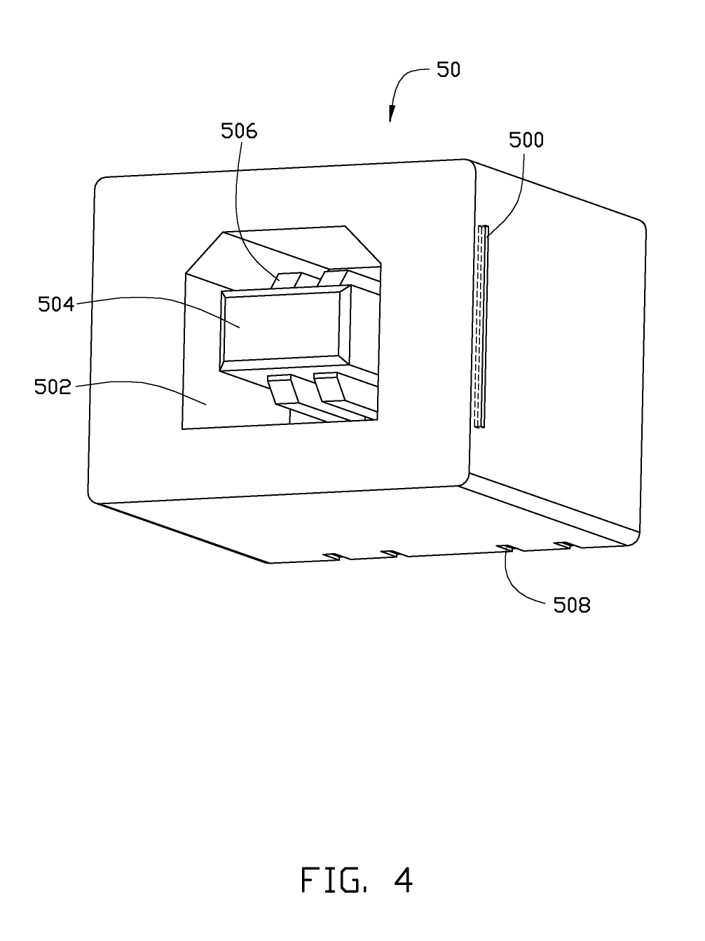

FIGS. 3 and 4 illustrate the second kernel 50 that is a male interface of type B. The second kernel 50 is the same as the first kernel 20 in size. Two slots 500 are defined in outer surfaces of the right and left sides of the second kernel 50. Four third pins 508 are arranged on a bottom of the second kernel 50. Differences between the first and second kernels 20 and 50 are that a height of a second hole 502 defined in a front side of the second kernel 50 is greater than a height of the first hole 206, a thickness of a second fixing piece 504 housed in the second hole 502 is thicker than the first fixing piece 204, two of four fifth pins 506 are arranged on a top of the second fixing piece 50, and the other two fifth pins 506 are arranged on a bottom of the second fixing piece 50. The fourth pins 508 are respectively coupled to the fifth pins 506.

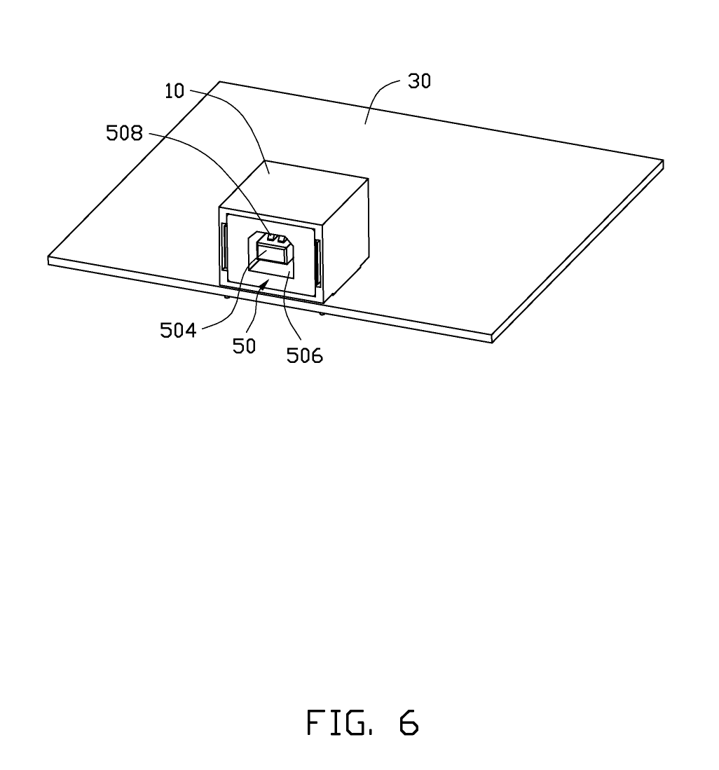

FIGS. 5 and 6 respectively illustrate using states of the first and second kernels 20 and 50. In use, the fixing pins 108 are welded into and electrically connected to the motherboard 30. When an electronic device with a type A interface needs to be connected to the motherboard 30, the first kernel 20 is fixed to the shell 10.

When an electronic device with a type B interface needs to be connected to the motherboard 30, the second kernel 50 is fixed to the shell 10.

In other embodiments, other kernels with other types of interfaces, such as mini B or micro B may be fixed to the shell 10.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A universal serial bus (USB) connector, comprising:
a box-shaped shell, wherein a front side of the shell is open, and four first pins are formed on an inner surface of a bottom wall of the shell; and
a kernel detachably received in the shell from the open front side of the shell, the kernel comprising a connector interface;
wherein a front side of the kernel defines a hole, a fixing piece is housed therein, four second pins are arranged on a bottom of the kernel and respectively connected to the first pins in response to the kernel being housed in the shell, four third pins is arranged on an outer surface of the fixing piece and electrically coupled to the four second pins, respectively.

2. The USB connector of claim 1, wherein two slots are defined in outer surfaces of left and right sides of the kernel, two snaps extend forward from inner surfaces of left and right sidewalls of the shell, to engage in the corresponding slots.

3. The USB connector of claim 1, wherein a plurality of fixing pins extends down from a bottom of the shell.

4. The USB connector of claim 1, wherein the connector interface is a type A USB interface, the four third pins are arranged on a bottom of the fixing piece.

5. The USB connector of claim 1, wherein the connector interface is a type B USB interface, two of the four third pins are arranged on a bottom of the fixing piece and the other two of the four third pins are arranged on a top of the fixing piece.
